(19) United States
(12) Patent Application Publication
(10) Pub. No.: US 2017/0103591 A1
(43) Pub. Date: Apr. 13, 2017

(54) DYNAMIC PROVISION OF TESTING PROTOCOLS

(71) Applicant: Charles E. Ramberg, Karlstad (SE)

(72) Inventor: Charles E. Ramberg, Karlstad (SE)

(21) Appl. No.: 15/289,618

(22) Filed: Oct. 10, 2016

Related U.S. Application Data
(60) Provisional application No. 62/239,070, filed on Oct. 8, 2015.

(51) Int. Cl. G07C 5/08; B60L 3/12; F02D 41/22

(52) U.S. Cl. CPC G07C 5/0808; F02D 41/22; B60L 3/12; G07C 5/085; B60L 2270/10

(57) ABSTRACT

Computer implemented methods may create unique hardware platforms suitable for providing and/or using testing protocols. A new protocol may be designed using a target protocol, such that the new protocol replicates one or more aspects of the target protocol. The new protocol may incorporate a certain diversity, which may make it more difficult for an entity being tested (e.g., a car, a truck, a person) to “cheat” the test (e.g., using knowledge of the target protocol). A new protocol may be calculated, validated, and provided “on demand.” A new protocol may be tailored to a particular set of test results (e.g., to highlight an apparent deviation between expected and actual results).

### CROSS REFERENCE TO RELATED APPLICATIONS

The present paper claims the priority benefit of U.S. provisional patent application No. 62/239,070 filed Oct. 8, 2015, the disclosure of which is incorporated herein by reference.

### BACKGROUND

1. Technical Field

The present invention relates generally to testing performance against a benchmark protocol, and more particularly to protocols that are more robust against cheating, particularly with respect to emissions testing.

2. Description of Related Art

Comparison of performance among products often entails the use of standardized testing. Typically, a standard or “benchmark” test imposes a predefined range of operating conditions. Such a test may be referred to as a standardized “duty cycle” or “protocol.” A benchmark protocol is used to compare different products. By testing performance of the different products under ostensibly equivalent test conditions, the relative performance of each product may be compared.

Historically, standardized test protocols been known prior to the testing of the product itself. For many modern products, a priori knowledge about the test itself may be used to “game” the test. This knowledge may be used to improve a product's performance on the standardized test, but this improvement may not be manifest in actual “real world” use.

A variety of technologies are subject to standardized testing—computing performance, electrical and communications performance, mechanical performance, and the like. Motor vehicles are typically subject to standardized testing.

Modern powertrains (e.g., comprising diesel, natural gas, gasoline, and other engines) are subject to emissions regulations. These regulations have been implemented to ensure that these powertrains perform in certain ways. A testing protocol (hereinafter: TP), such as an emissions-testing protocol, is used to test whether or not an apparatus (e.g., a car, truck, generator, ship, train, power plant, and the like, hereinafter: vehicle) meets certain regulatory requirements. A TP may be used to measure fuel consumption, CO2 emissions, emissions of criteria pollutants such as NOx, particulate matter, CO, unburned hydrocarbons, and the like.

Results of the TP are used to (among other things) compare apparatus. A vehicle may be advertised with a certain “gas mileage.” A vehicle may be verified as not emitting pollutants above a certain level. TP results (ostensibly) ensure that the public is accurately informed regarding the performance of the tested apparatus.

Prior TP suffer from a variety of problems. A TP may not represent real-world use, and so actual performance may vary from predicted performance. A car might get 40 mpg on an TP, yet get 35 mpg in the real world. A TP may not uniformly test different emissions. A truck used in one area might emit much more than a truck used in another area. An TP may test emissions in a way that benefits certain vehicles, to the detriment of others. Two cars might show the same fuel economy in a TP, yet one outperforms the other in real-life driving.

In some cases, a vehicle may recognize that it is running a TP and adjust its behavior accordingly. Modern powertrains include a variety of computer controlled systems. These systems may be used to “game” or “fool” or “defeat” an TP. A car, truck, train, tractor, wheel-loader, ship, and the like may have a computer (e.g., an engine control unit, or ECU) that causes the powertrain to operate one way during an TP (e.g., to meet regulatory requirements) and operate another way when not being tested. For example, a car might have a first fuel economy during the TP, and then have another (e.g., lower) fuel economy during real-world driving. A truck might have compliant emissions of NOx and/or PM during the TP, but yield noncompliant (e.g., too high) levels during real-world use.

An improved set of systems and methods, robust to “defeat devices,” would provide for improved testing of apparatus, thereby increasing the accuracy of testing protocols. Such improvements might aid regulators in identifying noncompliant devices, and may provide the public with better information for use when purchasing or leasing an apparatus.

### SUMMARY OF THE INVENTION

A device to request and/or provide a test protocol may comprise a computer processor and non-transitory storage media having embodied thereon instructions executable by the processor to perform one or more methods.

A method may comprise receiving a target protocol, particularly a standard test protocol, and discretizing the target protocol into a discrete representation comprising a plurality of tiles. A tile may comprise a discrete portion of a protocol, and a sequence of tiles may “represent” a protocol in a representation.

A representation may be permuted into a permuted representation. A new protocol based on the permuted representation may be calculated. The new protocol may be sent to a testing apparatus for use in testing a device (e.g., a powertrain, a vehicle, and the like).

In some cases, a derivative representation is calculated. The derivative representation may be permuted, and then summed or integrated to generate a new calculated representation.

Provision of a protocol may comprise incorporating the results from a prior test to generate a new test protocol. A first test result may be selected and/or received. An expected result for at least a portion of the first test result may be compared to the actual test result for that portion. A deviation between expected and actual may trigger the generation of an updated protocol. The updated (or “followup”) protocol may include a protocol chosen to focus on the test conditions that lead to the deviation. The updated protocol may be sent for use in a subsequent test (the results of which themselves may be used to generate subsequent protocols).

A protocol provision device may receive a request comprising protocol requirements, query a database for and/or calculate an “on-demand” protocol, and send this new protocol out for use in a test.

A device may comprise an interface (e.g., an OBD interface) to the control system of a powertrain (e.g., a vehicle). The interface may be used to impose a test protocol on the vehicle.

### BRIEF DESCRIPTION OF THE DRAWINGS

FIG. 1A illustrates a schematic map of emissions concentration as a function of engine operating conditions, according to some embodiments.

FIG. 1B illustrates a schematic map of emissions concentration as a function of engine operating conditions, according to some embodiments.

FIG. 1C illustrates an exemplary “emissions tradeoff” curve, according to some embodiments.

FIGS. 2A, 2B, and 2C illustrate exemplary tradeoffs, according to some embodiments.

FIG. 3 illustrates an exemplary standardized test protocol, according to some embodiments.

FIGS. 4A and 4B illustrate a test protocol and a derivative protocol, according to some embodiments.

FIG. 5 illustrates an exemplary derivative protocol, according to some embodiments.

FIGS. 6A, 6B, and 6C illustrate a target protocol and two derivative protocols, according to some embodiments.

FIG. 7 illustrates a representation of an effect of diversity in “protocol space” on measured performance, according to some embodiments.

FIGS. 8A-8D schematically illustrate several representative protocols, according to some embodiments.

FIG. 9 illustrates a method for generating a protocol, according to some embodiments.

FIG. 10 provides additional information regarding an embodiment.

FIG. 11 provides additional information regarding an embodiment.

FIG. 12 provides additional information regarding an embodiment.

FIG. 13 provides additional information regarding an embodiment.

FIG. 14 illustrates an exemplary discrete representation and its associated target protocol, according to some embodiments.

FIGS. 15A and 15B illustrate exemplary embodiments.

FIGS. 16A, 16B, and 16C illustrate exemplary embodiments.

FIGS. 17A, 17B, and 17C illustrate different permutations, according to some embodiments.

FIGS. 18A and 18B illustrate exemplary compliance calculations, according to some embodiments.

FIGS. 19A, B, and C illustrate exemplary compliance verification, according to some embodiments.

FIG. 20 illustrates an exemplary method for verifying the compliance of one or more descriptors of a representation, according to some embodiments.

FIG. 21 illustrates an exemplary histogram, according to some embodiments.

FIGS. 22A, 22B, and 22C illustrate diversity in “bin space” according to some embodiments.

FIGS. 23A, 23B, and 23C illustrate diversity in “bin space” according to some embodiments.

FIG. 24 illustrates a networked implementation, according to some embodiments.

FIG. 25 illustrates an exemplary implementation of a platform, according to some embodiments.

FIGS. 26 and 27 illustrate an exemplary implementation.

FIG. 28 illustrates an exemplary implementation.

FIG. 29 illustrates a method, according to some embodiments.

FIGS. 30A-D illustrate an exemplary illustration of protocol generation, according to some embodiments.

### DETAILED DESCRIPTION OF THE INVENTION

Comparison of the performance of different competitive products often entails the use of standardized testing. For some applications, knowledge about (e.g., sensing of, history of, prediction of) a test protocol may be used improve the apparent performance of the product during testing. In the “real world,” different coordinates/combinations of operating conditions may be used (e.g., to provide increased performance). As a result, real-world performance deviates from testing performance; a device may perform well during testing, yet poorly during real-world use.

The accuracy of testing using standardized test protocols may be endangered with a priori knowledge about the test itself. Various aspects provide for the dynamic provision of testing protocols. By testing according to a protocol generated “on demand,” a test subject (e.g., a computing device) may have a harder time tailoring its performance to the test. As a result, it may be more difficult to “game” the test.

Systems and methods described herein may be used to detect “cheating” or other non-compliant test results. The use of a “defeat device” may be detected using suitably designed test protocols. In some cases, test protocols are provided dynamically, such that prior to testing, the device being tested is not aware of the test conditions.

The accuracy and reproducibility of a dynamically generated protocol may be improved using statistical methods. By comparing an observed result with a predicted result, and accounting for statistical variation (e.g., based on historical test results), a significant deviation (actual vs. expected) may be identified. In some cases, a significant deviation may trigger a followup test, which may be an additional protocol that imposes conditions that emphasize (e.g., confirm or refute) the aberrant behavior observed in the first test.

Various aspects provide for the generation of a test protocol that more accurately represents real-world operation as compared to a prior “standardized” test protocol. Certain aspects generate a test protocol that “highlights” or identifies an apparatus running software designed to “game” or “defeat” the test protocol (e.g., a regulatory test protocol). Certain aspects provide for a technical software service, in which test protocols are provided upon demand (e.g., to a test center). Results from a first protocol may be used to generate a second “followup” protocol that focuses on certain aspects of the results (e.g., noncompliant portions of a duty cycle). Certain aspects utilize the results of a plurality of prior tests (according to one or more different protocols) to generate new protocols (e.g., to determine an expected error for a result and/or compare a new result to an expected result, optionally with the inclusion of the standard error). Certain aspects receive user input (e.g., actual gas mileage) and utilize this input to determine a new test protocol (e.g., for specific vehicles).

Computer implemented methods may create unique platforms suitable for providing and/or using testing protocols. A platform may comprise hardware (e.g., processor, memory, communications) and software executable by the processor to perform one or more methods. Some aspects may be implemented using SaaS and/or a client-server deployment model.

A new protocol may be designed using a target protocol, such that the new protocol replicates one or more aspects of the target protocol. The new protocol may incorporate a certain diversity, which may make it more difficult for an entity being tested (e.g., a car, a truck, a person, a computer chip, a network, a communications path, and the like) to “cheat” the test (e.g., using knowledge of the target protocol). A new protocol may be calculated, validated, and provided “on demand.” A new protocol may be tailored to a particular set of test results (e.g., to highlight an apparent deviation between expected and actual results).

Various aspects are described in the context of emissions testing, which may impose (for example) a test protocol having an imposed speed vs. time, power vs. time, torque vs. speed, and the like. A test result (e.g., fuel consumption, pollutant emission) may be correlated with the test protocol used to generate the result. In some embodiments, a test may comprise an expected value vs. (for example) of signal intensity vs. wavelength/wavenumber, vs. chemical concentration, molecular weight, and the like. Systems and methods described herein may be implemented across a wide range of technologies.

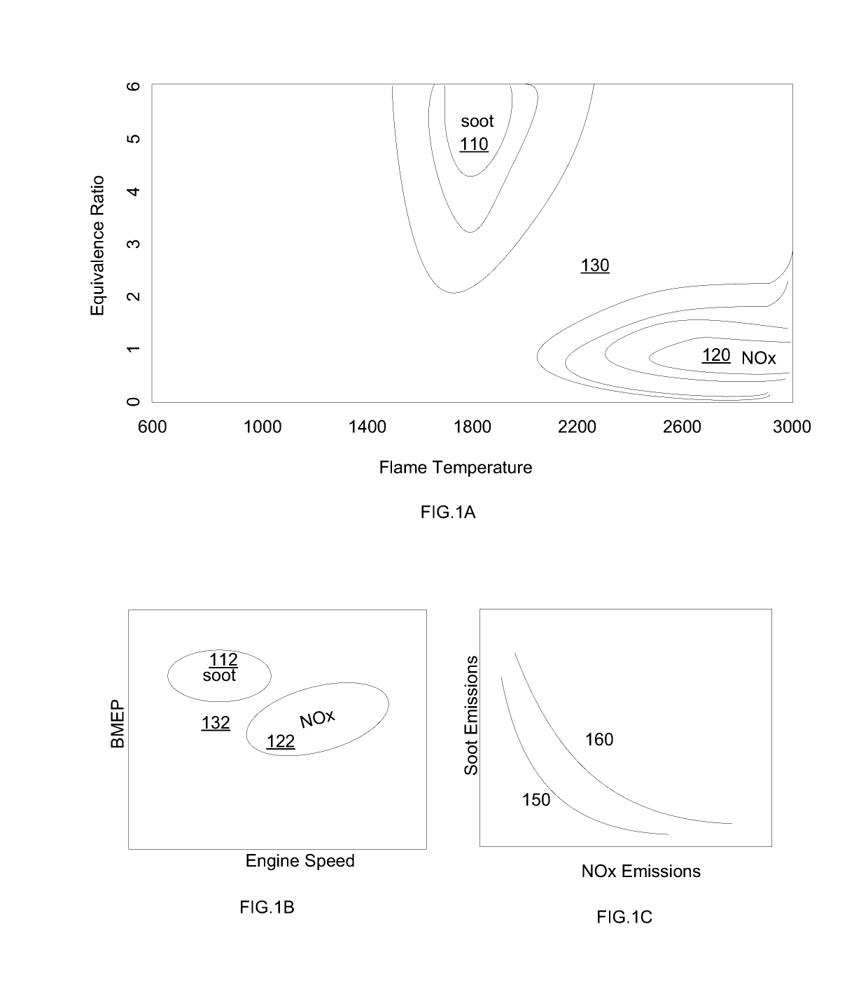

FIG. 1A illustrates a schematic illustration of a map of emissions concentration as a function of engine operating conditions, according to some embodiments. In this example, different operating conditions may result in a range of combinations of flame temperature and equivalence ratio. A first operating condition 110 may result in relatively high concentrations of soot in the emissions stream. A second operating condition 120 may result in relatively high concentrations of NOx in the emissions stream. A third operating condition 130 may result in relatively low concentrations of soot and NOx. Typically, an engine control unit (ECU) may choose an operating condition from among a plurality of points on a so-called “engine map,” which yields the conditions that yield the test results.

FIG. 1B illustrates a schematic map of emissions concentration as a function of engine operating conditions. Typically, a device may be operated in a way that increases a certain type of output yet decreases another type of output (and vice versa). For example, a first combination 112 of Brake Mean Effective Pressure (BMEP) and engine speed (e.g., power) may result in increased soot emissions. A second combination 122 of BMEP and engine speed may result in increased NOx emissions. A third combination 132 may result in reduced emissions of soot and NOx. Inasmuch as decreasing both soot and NOx are desirable, combination 132 might be viewed as the “best” combination. However, if this combination is not used in the real world, it may have little meaningful effect.

FIG. 1C illustrates an exemplary “emissions tradeoff” curve, according to some embodiments. A powertrain may be characterized by a first combination of emitted soot and NOx. In some cases, a first curve 150 may describe a range of emitted soot and NOx during a first range of operating conditions (e.g., a standardized test protocol). A second curve 160 may describe a range of emitted soot and NOx during a second range of operating conditions (e.g., real world driving). A computing device (e.g., and ECU) that can discern that it is being subject to the standardized test protocol may be programmed to operate according to first curve 150, yielding apparently low emissions.

However, the operating conditions yielding first curve 150 may not be commercially desirable. For example, the conditions associated with first curve 150 may yield slower acceleration and/or less “driving enjoyment,” while the conditions yielding second curve 160 yield faster acceleration and greater driving enjoyment (and by extension, greater consumer acceptance, market share, and the like). Having identified that it is being subject to a standardized test, the device may perform in a way that does not accurately represent real-world performance, and real-world emissions may exceed those expected based on the standardized test results.

FIGS. 1A-C are simplified 2D projections. A higher dimensionality “results-space” may be generated, and a typical ECU has a wide variety of “knobs” that can be adjusted to change operating conditions.

Knowledge of an engine map associated with an engine may be used to estimate emissions as a function of different load requirements (e.g., torque, power). In some cases, a demand for torque and/or power may be received. A predicted emissions stream based on a first set of operating conditions (e.g., engine operating conditions) may be calculated (e.g., a first position on an engine map). A second set of operating conditions (e.g., a different position on an engine map) may result in different emissions (e.g., a higher amount of NOx, CO2, PM, and the like). A combination of motive forces (e.g., motor and engine) may be determined that results in engine operating conditions (e.g., a third position on the engine map) that yields an improved emissions stream.

Some engines emit high quantities of pollutants under conditions of maximum torque and/or maximum power. Some powertrains use a supplementary motive force (e.g. an electric motor) to provide a torque boost and/or power boost to an engine, such that peak emissions are reduced. New technology may be used to change the positions of the curves. For example, a non-hybridized vehicle that emits according to curve 160 may be hybridized with a battery and electric motor. The hybridized vehicle may emit according to curve 150, yet still offer the performance of the non-hybridized vehicle emitting according to curve 160.

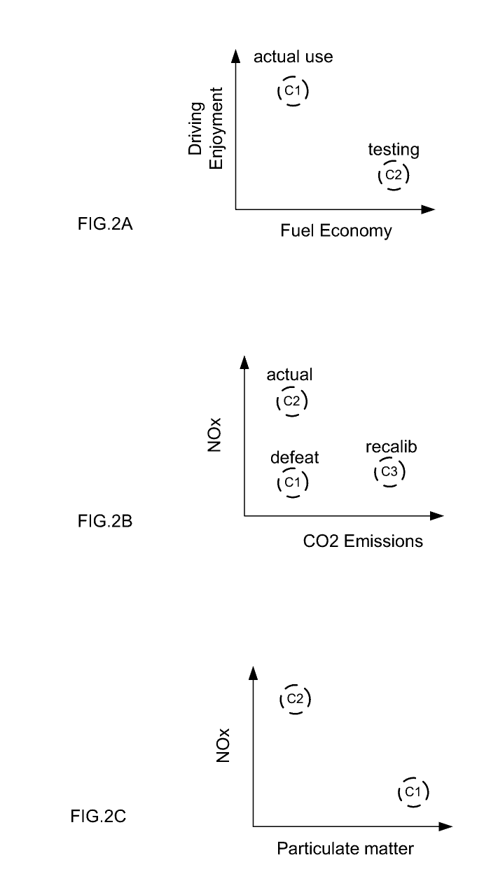

FIGS. 2A, 2B, and 2C illustrate exemplary tradeoffs, according to some embodiments. Different operating conditions may be annotated as C1, C2, and C3. In FIG. 2A, C1 may be a condition used during actual use (e.g., by a driver of a car), and may result in high driving enjoyment (e.g., fast throttle response) but low fuel economy. C2 may be a condition used during testing (e.g., during a standardized EPA mileage or emissions test) that yields higher fuel economy, but lower “driving enjoyment” (notwithstanding that there may be no driver). Modern, computer-controlled apparatus may detect when they are being tested, and thus implement C1 automatically (e.g., only during testing). Testing authorities might be fooled if an apparatus is tested with the engine controlled according to conditions C2 but (in real life) users actually operate the apparatus according to conditions C1.

FIG. 2B illustrates an exemplary tradeoff between NOx and CO2 emissions, according to some embodiments. C1 (e.g., using a defeat device) may result in low NOx and low CO2 (but might never be used in the real world). Operating in the “real world” (e.g., controlled to C2 conditions) may result in much higher NOx. A third (e.g., recalibrated) condition might result in relatively lower NOx, but higher CO2 emissions.

FIG. 2C illustrates an exemplary tradeoff between NOx and soot. Operating according to condition C1 might create a lot of soot, but relatively little NOx. Operating according to C2 might create relatively little soot, but high NOx. By appropriately choosing operating conditions (e.g., according to whether or not NOx or soot is more detrimental), an apparatus may be “gamed” to fool a test. For example, a powertrain operating according to condition C2 might not need a particulate filter, whereas a powertrain operating according to condition C1 might need a particulate filter. A manufacturer seeking to avoid the cost of a particulate filter might choose to use C2 conditions during testing. A manufacturer seeking to avoid the cost of a selective-catalytic reduction (SCR) system to reduce NOx might choose to use C1 during testing. In the real-world, minimizing emissions might require the use of both a particulate filter and an SCR system, but the standardized test may not identify this need.

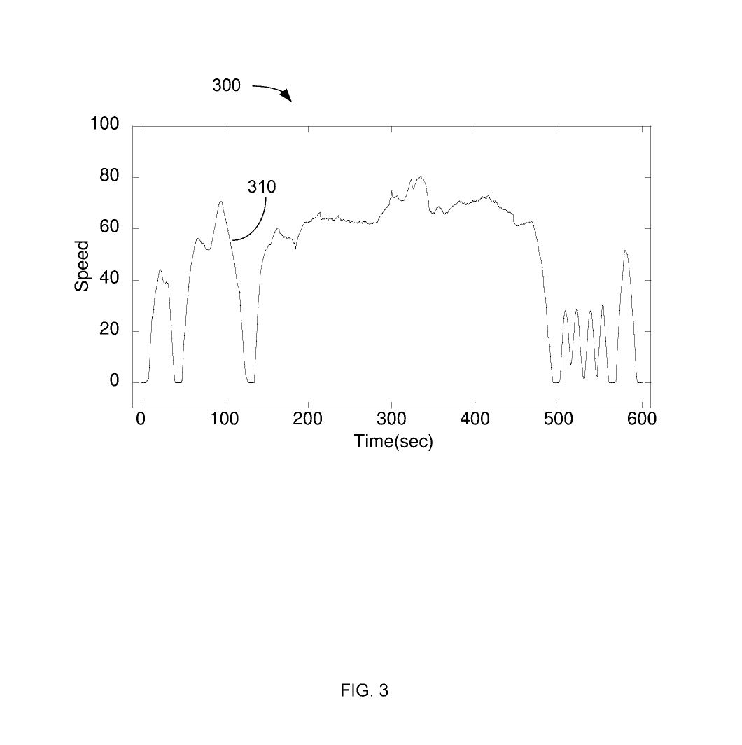

FIG. 3 illustrates an exemplary standardized test protocol, according to some embodiments. In this example, a target protocol 310 (in this case, the US06 light duty protocol) may impose a standardized mileage and/or emissions test protocol. A protocol may comprise a recommended and/or imposed set of conditions (in this example, speed vs. time). In an exemplary test, a vehicle is controlled to achieve the speed vs. time response shown in protocol 310, and the resulting emissions are measured. Historically, such standardized protocols are known a priori.

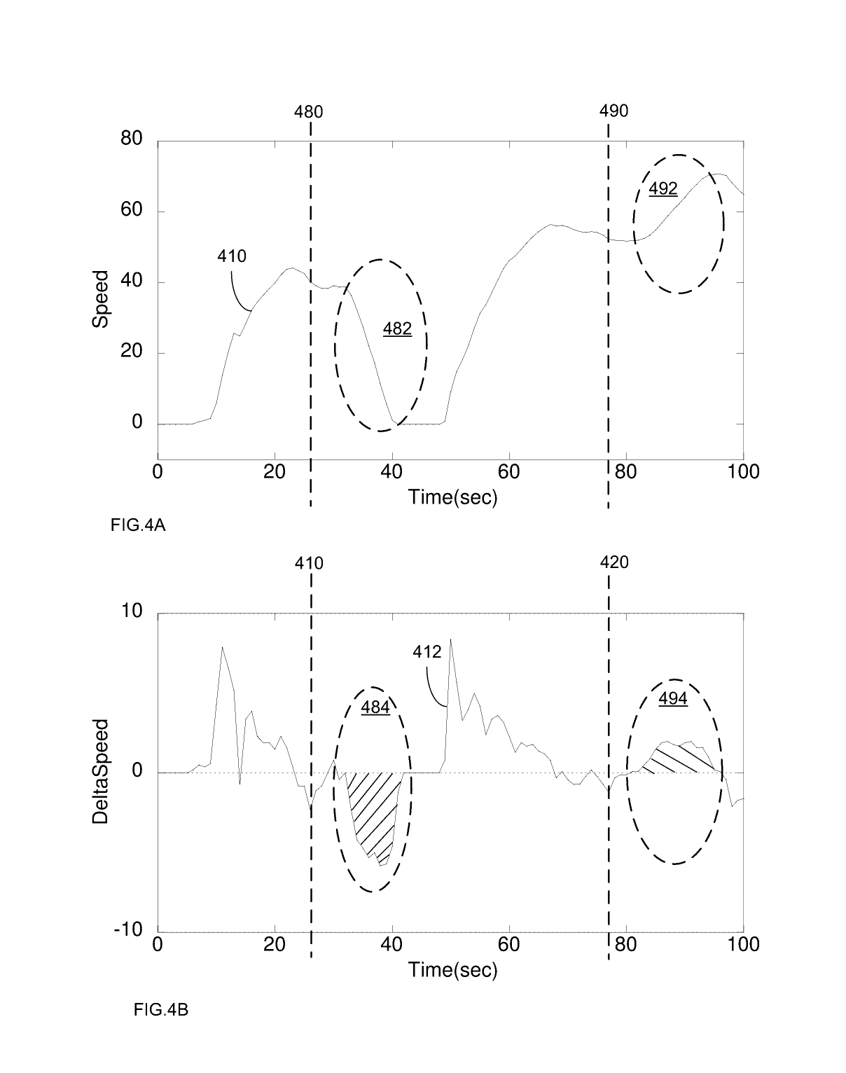

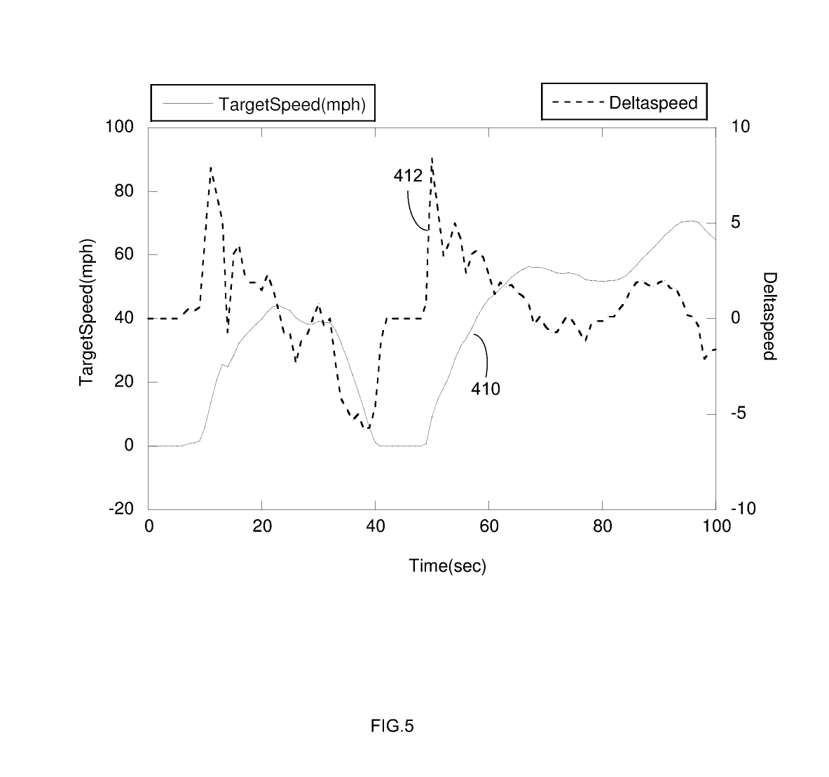

FIGS. 4A and 4B illustrate a test protocol and a derivative protocol, according to some embodiments. FIG. 4A illustrates a portion of a target protocol 410 comprising speed vs. time (e.g., for a vehicle emissions test). FIG. 4B illustrates a derivative protocol 412 derived from the target protocol. In this example, derivative protocol 412 corresponds to a representative acceleration vs. time needed to achieve the speed vs. time test protocol 410 in FIG. 4A.

In typical testing conditions, the protocol is known a priori. Thus, information about an expected future demand may be used to optimize the response to a current demand. For example, times 480 and 490 are shown on both FIGS. 4A and 4B. The speed may be different at each time (FIG. 4A), but the acceleration rates may be similar—the tested vehicle may be “coasting” at similar deceleration rates (FIG. 4B).

However, the “expected future behavior” after time 480 may be quite different from that after time 490. At time 480, a “future braking” demand 482 may be associated with an opportunity 484 to “recover energy from wheels.” At time 490, a “future acceleration” demand 492 may be associated with a need 494 to “deliver extra energy to wheels.” While the instantaneous powertrain demands at times 480 and 490 may be similar, the future demands and responses may be quite different.

Knowing these differences in future demands, a vehicle may be operated in a way that most efficiently leverages this knowledge, which may defeat the objectivity of the test protocol. Battery charging may be delayed (or not); aftertreatment regeneration may be delayed (or not).

FIG. 5 illustrates an exemplary derivative protocol, according to some embodiments. A target protocol 410 may be used to calculate a derivative protocol 412. In this example, a target protocol comprises speed vs. time, and a derivative protocol comprising the acceleration vs. time needed to achieve the target protocol is calculated. A derivative protocol may be more “jagged” than a target protocol, and a “derivative of a derivative” protocol (e.g., accelerator pedal position) may be even more jagged.

With statistical error, each of a select group of derivative protocols may be “integrated” to yield (within experimental error) the same “target” protocol. By extension, a large number of “2^{nd} derivative” protocols may be “integrated” to yield substantially the same “target” protocol. As such, diversity in a “protocol space” may be used to impose diversity in the “engine map space,” forcing the engine to operate in different (e.g., unknown) ways.

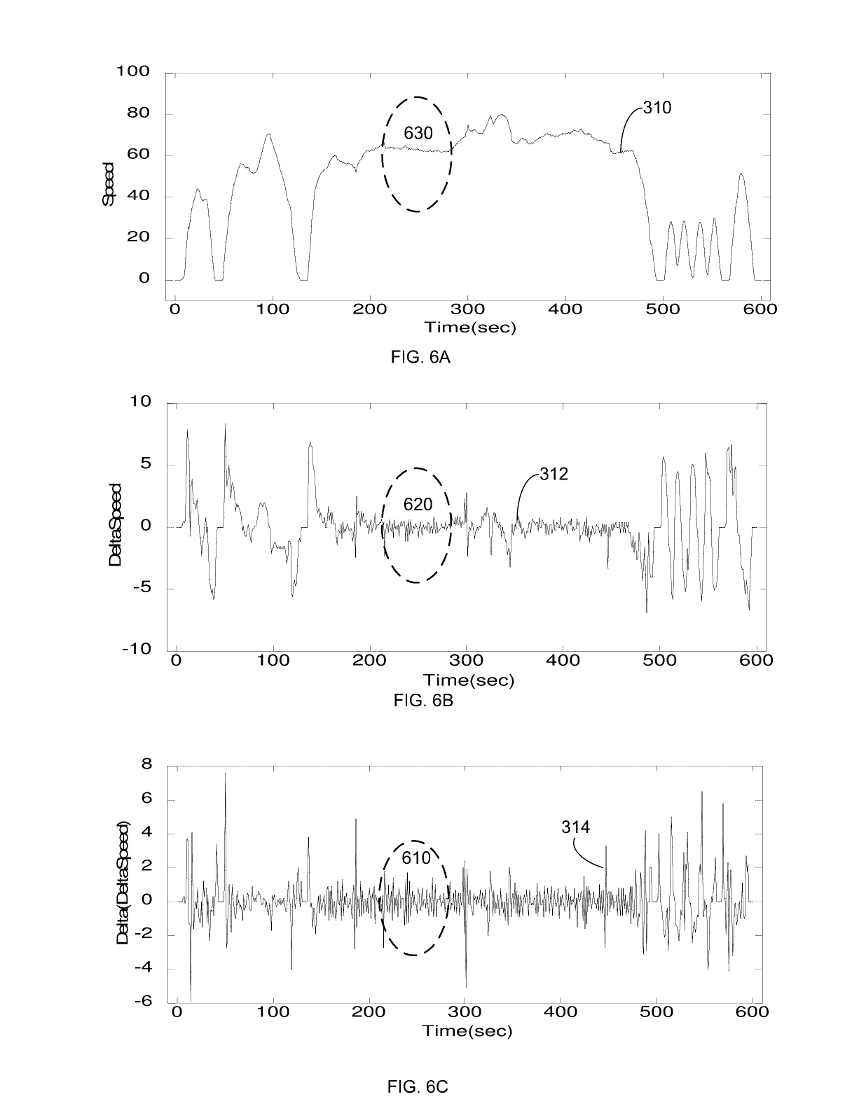

FIGS. 6A, 6B, and 6C illustrate a target protocol and two derivative protocols, according to some embodiments. A target protocol (e.g., speed vs. time) may be used to calculate a first derivative protocol (e.g., acceleration vs. time) needed to achieve the target protocol The first derivative protocol may be used to calculate a second derivative protocol (e.g., “pedal position” vs. time that may describe the position of an accelerator or brake pedal). The second derivative protocol may comprise a protocol needed to achieve the “acceleration vs. time” that is needed to achieve a desired “speed vs. time.” Modern apparatus are typically computer controlled (e.g., “drive by wire”); as such “pedal position” is merely a descriptor of a set of operating conditions that may be controlled by an engine control unit (ECU). A first condition may correspond to “full throttle” (wherever the accelerator pedal actually is) and a second condition may correspond to “full brake” (wherever the brake pedal actually is).

A target protocol 310 (FIG. 6A, e.g., speed vs. time) may be used to calculate a derivative protocol 312 (e.g., acceleration vs. time), which may be used to calculate another derivative protocol 314 (FIG. 6C). Conversely, derivative protocols may be “integrated” to calculate a target/new protocol.

In some embodiments, a protocol is permuted to generate many (e.g., tens, hundreds, thousands, millions) of possible combinations. These combinations may be tested (e.g., for compliance with apparatus limitations), resulting in one or more new protocols.

The available diversity of protocols in “protocol space” may be illustrated using FIGS. 6C, B, and A. A variety of “similar-looking” portions 610 (FIG. 6C) may be used to generate corresponding portions 620 (FIG. 6B), each of which is sufficiently similar to portion 630 (FIG. 6A) that it may be used for testing. A test protocol may “look like” a target (e.g., standard) protocol, but may not be exactly like it. Two protocols may appear different, but yield substantially the same test result. In some cases, a new protocol looks completely different from a standard protocol, but tests (or “samples”) substantially the same range of operating conditions. By generating a plurality of possible protocols, a diversity in testing parameters may be imposed on the entity being tested. For example, using a new protocol, a change in the “operating condition space” of the engine control unit may be imposed. A test protocol may obligate an ECU to operate in a condition in which its performance may be more accurately measured.

By generating a large number of possible protocols, a large and unknown range of test conditions may be imposed. Inasmuch as the range of test conditions represents real-world operation, these test protocols may better represent real-world performance. Inasmuch as the protocol is unknown, it may be harder to defeat the testing procedure.

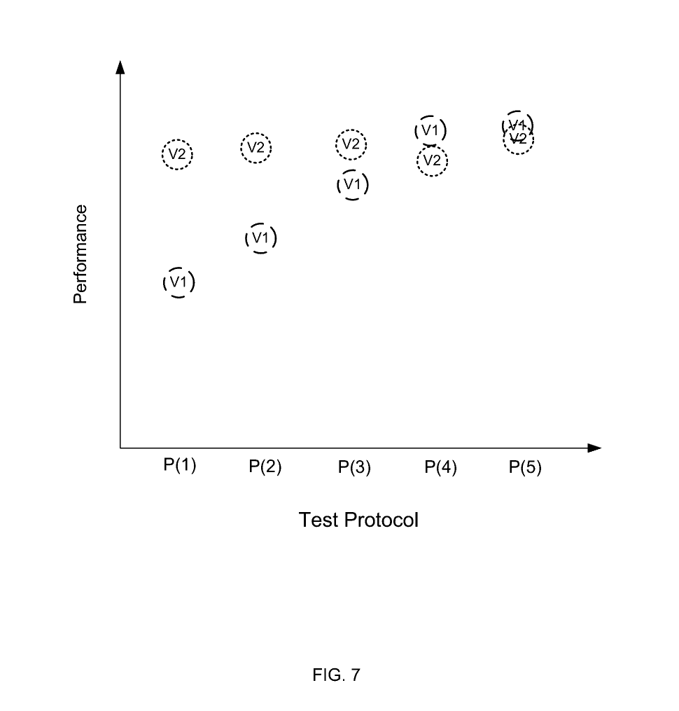

FIG. 7 illustrates a representation of an effect of diversity in “protocol space” on measured performance, according to some embodiments. Different test subjects (e.g., apparatus, chips, vehicles, and the like) may be represented by V1, V2, and the like. Test protocol P(5) might yield results suggesting V1 and V2 perform similarly (e.g., emit similar NOx levels), whereas protocol P(1) may suggest that V2 emits higher levels of NOx than V1. By choosing a protocol that best represents real-world use, the accuracy of testing may be improved. In some cases, a deviation between standard results and real-world results is common (e.g., “your mileage may vary”). In some cases, one vehicle (e.g., V2) might “trick” protocol P(1), whereas V1 does not, and so the apparent difference between the performance of V1 and V2 might not be manifest in actual, real-world driving.

Protocol diversity may improve the quality of test data. For example, for a vehicle V2 employing a defeat device (artificially increasing test performance) vs. V1 without such a device, results of a (prior art) protocol P(1) suggest that V2 is “better” than V1. New protocols P(2), P(3), P(4), and P(5) may show different differences between V1 and V2. In some cases, a protocol is generated that more accurately represents the difference (or lack thereof) between two (ostensibly similar) test subjects. A protocol may be designed to emphasize or “highlight” when an apparatus is being operated with a “defeat device” or other (software or hardware) component that fools standard testing protocols. In some cases, a test protocol that identifies a particular type of “bad behavior” is used.

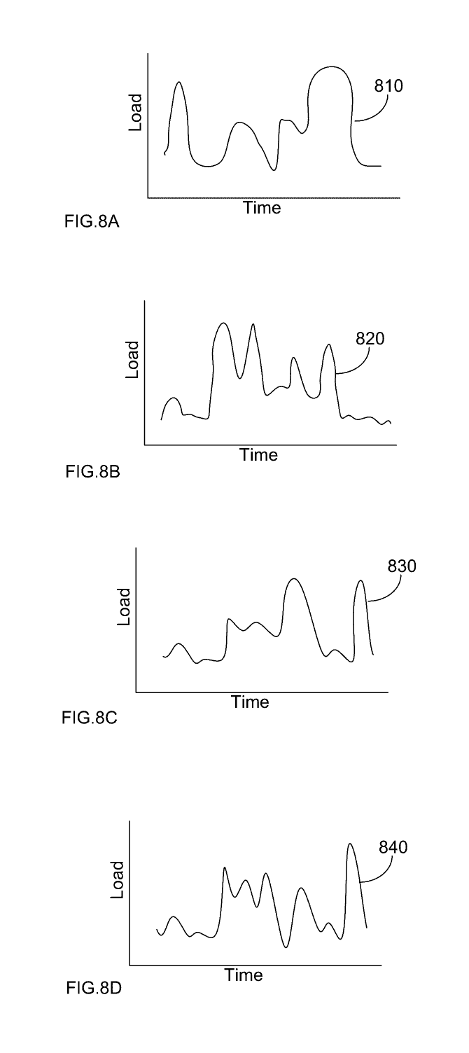

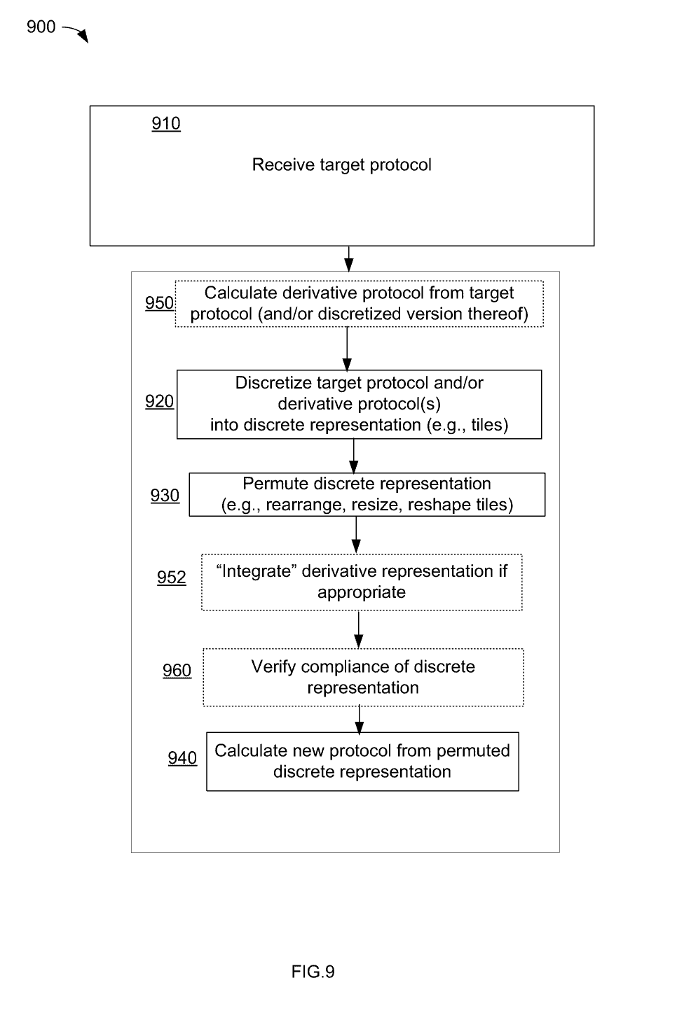

FIGS. 8A-8D illustrate several representative protocols, according to some embodiments. A prior art protocol 810 (FIG. 8A) may be used to test Car1 and Car2, yielding test results suggesting that Car2 has better gas mileage. New protocols 820 (FIG. 8B) 830 (FIG. 8C) and 840 (FIG. 8D) may be calculated. Table 1 summarizes prophetic results for these protocols. Each protocol may “highlight” a different aspect of performance and/or “engine map space.” Testing according to protocol 2 may yield the same mileage for Car1 and Car 2, but this mileage may not be accurate. Protocol 3 may yield accurate representations of real-world mileage for each of Car1 and Car2. Protocol 4 may be designed to emphasize a certain test aspect (e.g., cold weather, high altitude, urban) and/or emphasize a certain deviation from acceptable behavior (e.g., a high-soot protocol). A larger deviation may be associated with a device that is less acceptable under these conditions.

TABLE 1

| | Car1 (ungamed) | | Car2 (gamed) | |
|---|---|---|---|---|
| Protocol | 27 mpg in real-world | | 26 mpg in real-world | |
| 1 | 30 | mpg | 40 | mpg |
| 2 | 29 | mpg | 29 | mpg |
| 3 | 27 | mpg | 26 | mpg |

| | | |
|---|---|---|
| 4 | 5% below expected | 20% below expected |

FIG. 9 illustrates a method for generating a protocol, according to some embodiments. A method 900 may comprise receiving (910) a target protocol. A target protocol may comprise a previously defined “standardized test” protocol (e.g., FTP-75, US06, JC08, WLTP, WHSC, WHTC, NRTC, ISO 8178, UDDS, HHDDT, NEDC, 10-15 Mode, 13-Mode, Euro V/VI, Tier IV, CUEDC, SPC240, HWFET, FTP Transient, CSC, NY Composite). A target protocol may comprise a protocol having desired characteristics (e.g., sensitive to hybrid vehicles, sensitive to diesels, sensitive to urban driving). A target protocol may comprise speed vs. time, load vs. time, power vs. time, and the like.

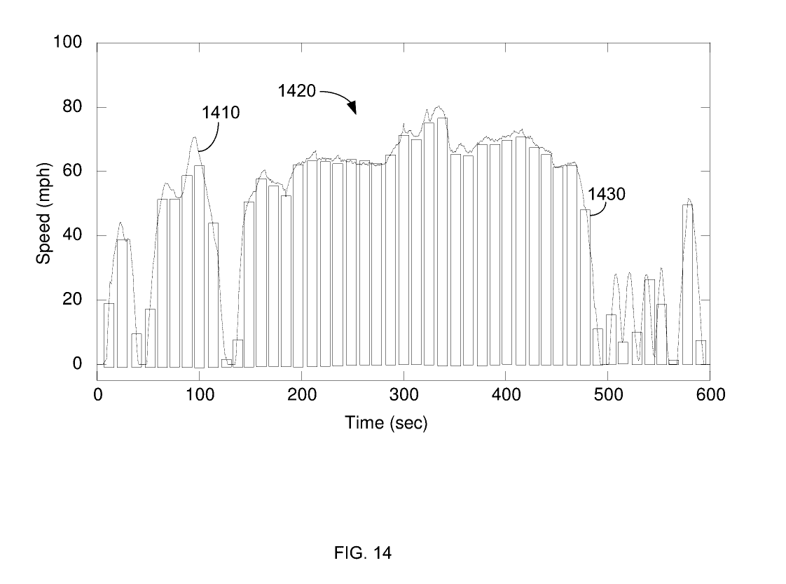

The target protocol may be discretized (920) into discrete components. For illustrative convenience, these discretized components may be described as “tiles.” A tile may comprise a portion of a protocol, having properties (e.g., geometry) that facilitate subsequent numerical calculations. A plurality of tiles may be aggregated (e.g., temporally) to form a discrete representation of the target protocol (e.g., see FIG. 14). For example, a tile may comprise a certain speed for a certain time (in a speed vs. time protocol).

The discrete representation may be permuted (930) to introduce diversity into the representation. The magnitude and form of the diversity may be chosen according to an expected sensitivity (e.g., of the tested response) to the diversity. Permution may comprise the introduction of (e.g., randomized) deviation into various parameters. For example, a distribution of allowed deviation from a mean value may be identified. A randomly selected tile may be adjusted (e.g., width, height) by a randomly selected amount from this distribution. A randomly selected tile may be extracted from its position in a representation and removed or inserted elsewhere.

A new protocol may be calculated (940) from the permuted representation. The new protocol may then be used (e.g., for testing). A new protocol may be a “proxy” for the target protocol. The new protocol may represent the target protocol in certain ways. The new protocol may differ from the target protocol in certain ways.

In some cases, compliance may be verified (960). Verification may comprise the verification of individual tiles (e.g., maximum speed below 100 kph), difference between tiles (e.g., maximum acceleration rate), and the like. Verification may comprise the calculation of “representation-wide” data (e.g., mean(s), standard deviation(s) and the like) and/or histograms describing the representation, and the comparison of the data against one or more benchmarks.

In some cases, a derivative protocol may be calculated (950), e.g., from a target protocol. A protocol may be integrated (952) (e.g., to yield a new test protocol). Discretization/permutation/integration may be performed on the derivative protocol to yield a new protocol. A protocol may be discretized into a first discrete representation, and a derivative representation may be calculated from the first discrete representation. Various steps may be performed in different order (e.g., derive, permute, then integrate, or permute, derive, permute, then integrate, or derive, derive, permute, integrate, integrate).

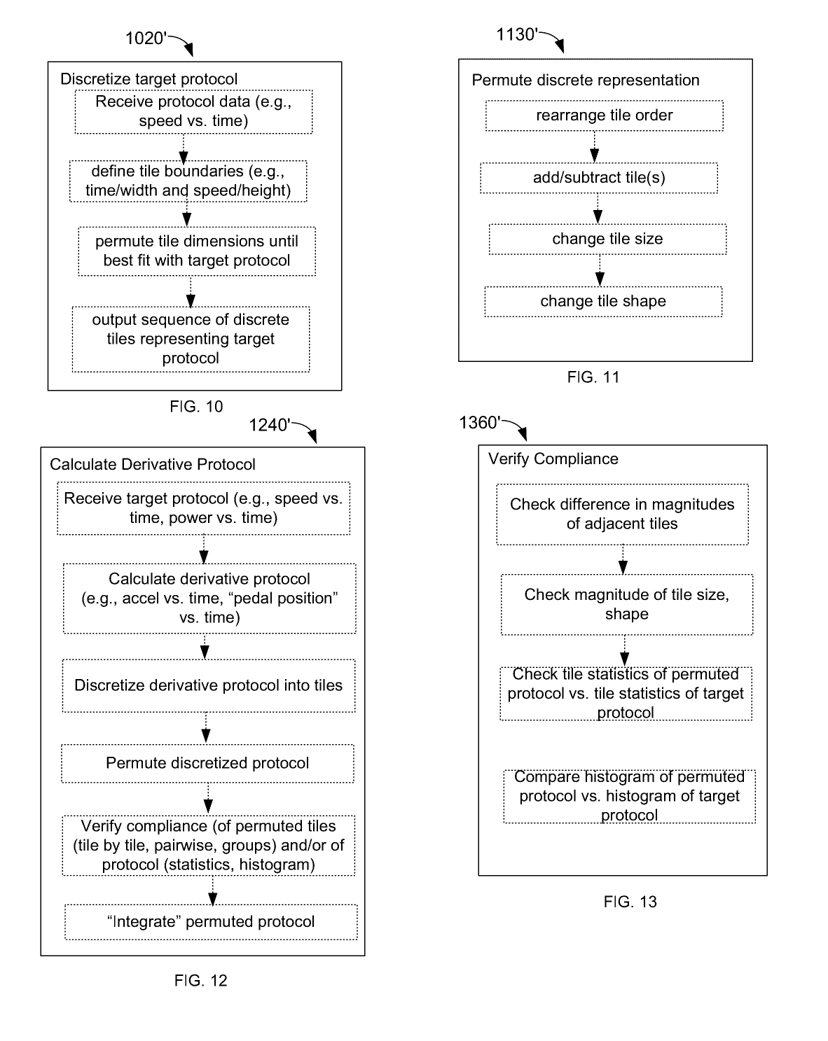

FIG. 10 provides additional information regarding optional aspects, according to an embodiment. FIG. 10 illustrates optional aspects associated with discretizing a protocol (e.g., a target protocol). Tile boundaries may be defined. Tile dimensions (based on these boundaries) may be permuted (e.g., until a best fit with the target protocol is reached). A sequence of tiles representing the target protocol may be output.

FIG. 11 provides additional information regarding an embodiment. FIG. 11 illustrates optional aspects associated with permuting a discrete representation (native, derivative, and the like). Tile order may be rearranged. Tiles may be added or subtracted. Tile size may be changed. Tile shape may be changed.

FIG. 12 provides additional information regarding an embodiment. FIG. 12 illustrates optional aspects associated with calculating a derivative protocol (e.g., from a target protocol). For illustrative purposes, other calculations (e.g., permutation, compliance) are also illustrated. The derivative protocol may be “integrated,” summed or otherwise used to calculate a new protocol. Compliance may be verified on a native protocol, a derivative protocol, and/or combinations thereof. A derivative protocol may be calculated.

FIG. 13 provides additional information regarding an embodiment. FIG. 13 illustrates optional aspects associated with verifying compliance. Compliance of a protocol may be verified (e.g., to ensure that damaging test conditions are not imposed on the test subject). Compliance of individual tiles may be verified (e.g., a maximum speed). Compliance of a difference between tiles may be verified (e.g., a maximum acceleration). Compliance with a statistical representation may be verified (e.g., with an average speed, with a standard deviation in acceleration, and the like). Histogram analyses may be used to assess compliance of a number of test results in a “bin” (e.g., of speeds) with an expected or desired value for that bin. Compliance with an aggregate limit on power consumption may be verified (e.g., to prevent overheating of a graphics card during testing of GPU performance).

FIG. 14 illustrates an exemplary discrete representation of tiles and its associated target protocol, according to some embodiments. Discretization of a protocol may facilitate permutation. Protocol 1410 is represented by the line in FIG. 14. Discrete representation 1420 comprises a plurality of tiles 1430. In this example, protocol 1410 corresponds to a desired speed vs. time (e.g., for an automobile emissions test). Tiles 1430 correspond (in this case) to quantized segments, each having a fixed duration and speed.

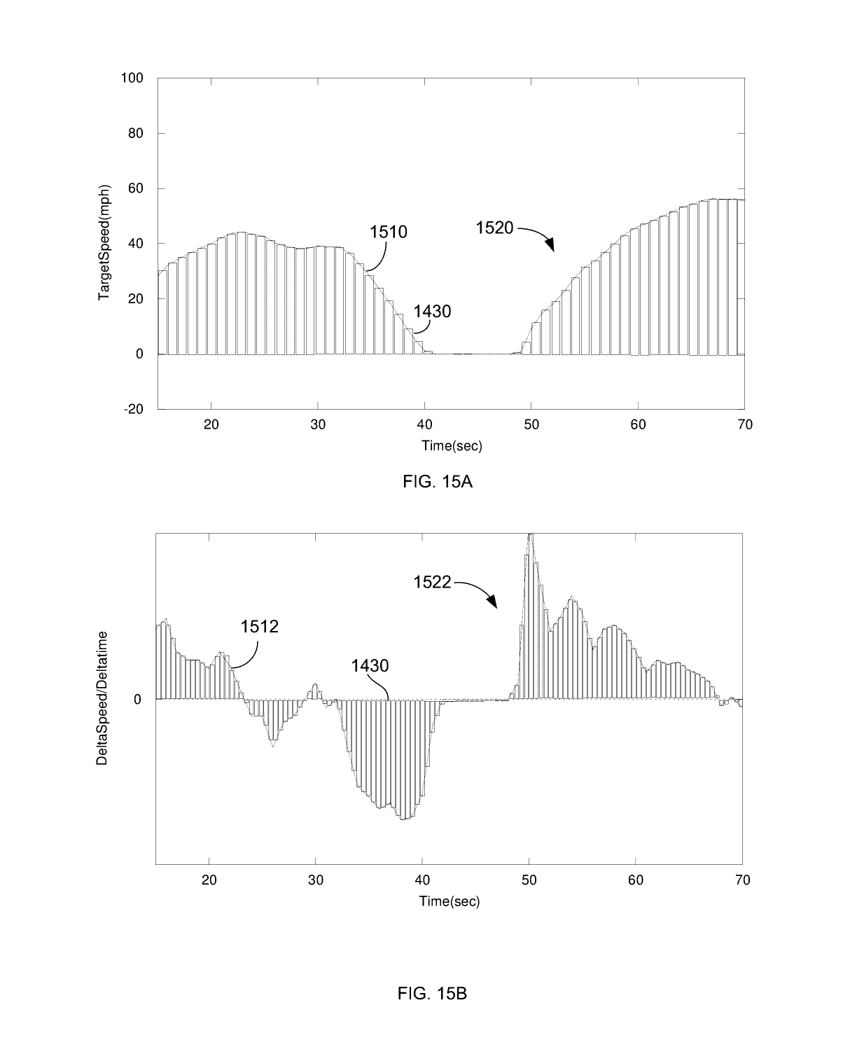

FIGS. 15A and 15B illustrate exemplary embodiments. In FIG. 15A, a target protocol 1510 (line) is represented by a “native” discrete representation 1520 comprising a plurality of tiles 1430. In FIG. 15B, a derivative protocol 1512 (line) is represented by a derivative representation 1522 of discrete tiles 1430. Tile dimensions, sizes, and shapes may be varied. In an embodiment, a derivative representation has “finer granularity” of tiles; in some cases vice versa. The derivative representation may have a statistical distribution (e.g., tile widths) that has a smaller mean than that of the associated native representation.

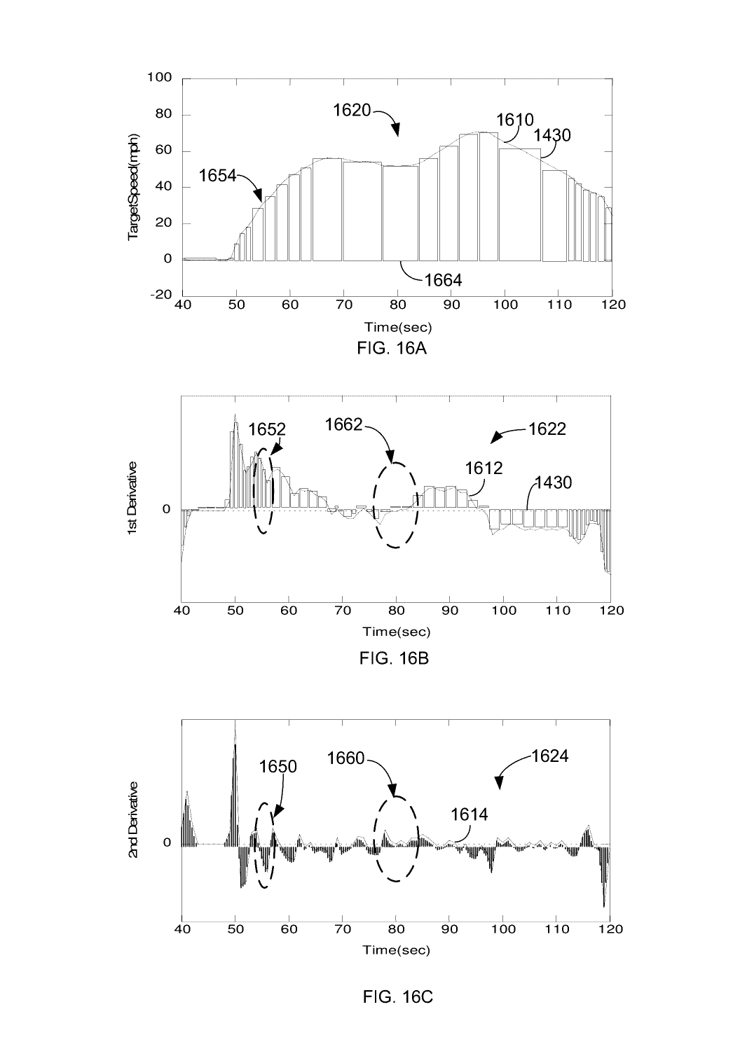

FIGS. 16A, 16B, and 16C illustrate exemplary embodiments. These figures illustrate examples of tile diversity. FIG. 16A illustrates a target protocol 1610 (line) represented by a first discrete representation 1620 of tiles 1430 having (in addition to varying heights) a range of widths. FIG. 16B illustrates a first derivative protocol 1612 (line) represented by a second discrete representation 1622 of tiles 1430 having a range of widths. FIG. 16C illustrates a second derivative protocol 1614 (line) represented by a third discrete representation 1624 of tiles 1430.

The width, height, number, and/or order of tiles may be varied. A representation (e.g., a derivative representation) may be permuted. A representation may be constrained to a desired feature (e.g., in a target protocol). For example (showing only a single permutation), different permutations of tiles in a portion 1650 (FIG. 16C) of a representation may be used to calculate respective portions 1652 (FIG. 16B) that themselves may be used to calculate differences 1654 in height between two adjacent tiles. A plurality of different combinations (e.g., of the tiles in portion 1650) may be generated, and a subset of those meeting the constraint 1654 may be selected.

A portion 1660 (FIG. 16C) of a representation may be used to calculate a portion 1662 (FIG. 16B) of another representation, which may be used to calculate one or more dimensions (e.g., width, height) of a specific tile 1664 (FIG. 16A). Tile combinations/dimensions/number may be permuted, and a subset of those permutations that fits a desired constraint may be selected.

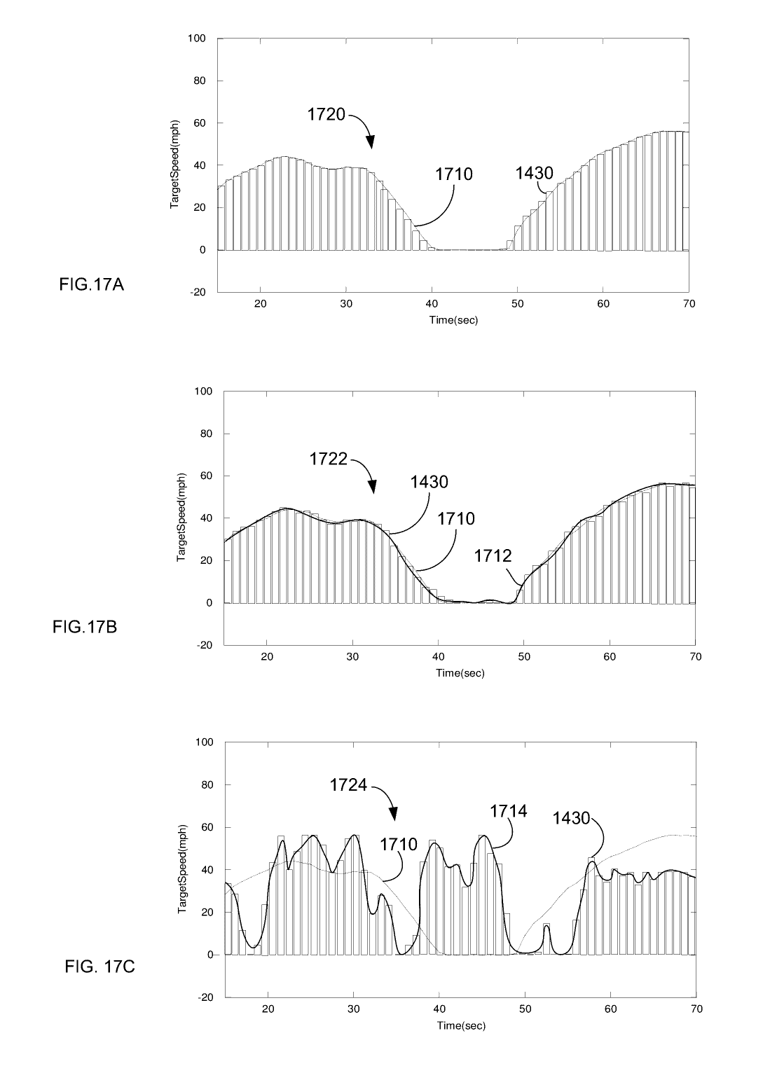

FIGS. 17A, 17B, and 17C illustrate different permutations, according to some embodiments. FIG. 17A illustrates a target protocol 1710 (line) and a first (e.g., “native”) representation 1720 of protocol 1710. FIG. 17B illustrates a first permuted representation 1722, overlaid on target protocol 1710 (line). Permuted representation 1722 comprises permutations of tile heights. In this example, a new protocol (e.g., the line calculated from the permuted representation) may substantially overlap with target protocol 1710.

FIG. 17C illustrates a second permuted representation 1724, overlaid on target protocol 1710 (fine line). A new protocol 1714 calculated from permuted representation 1724 is shown. In this permutation, tile order has been permuted, while height has been held constant. Comparing protocols 1710, 1712, and 1714, a vehicle tested according to each protocol may be obligated to achieve the same average combination of speed vs. velocity, but do so in different ways. By using an “unknown” protocol as a proxy for a “known” protocol, a vehicle's ability to defeat the test may be reduced. By controlling the protocol representation (to sample a desired range of engine conditions), protocol-to-protocol reproducibility may be maintained (e.g., two different protocols may be expected to generate similar results, notwithstanding that they are not identical).

Permutations have been illustrated separately for simplicity (FIG. 17B/heights; FIG. 17C/order). Permutations may be combined (including with other permutations, such as tile width, tile shape, and the like).

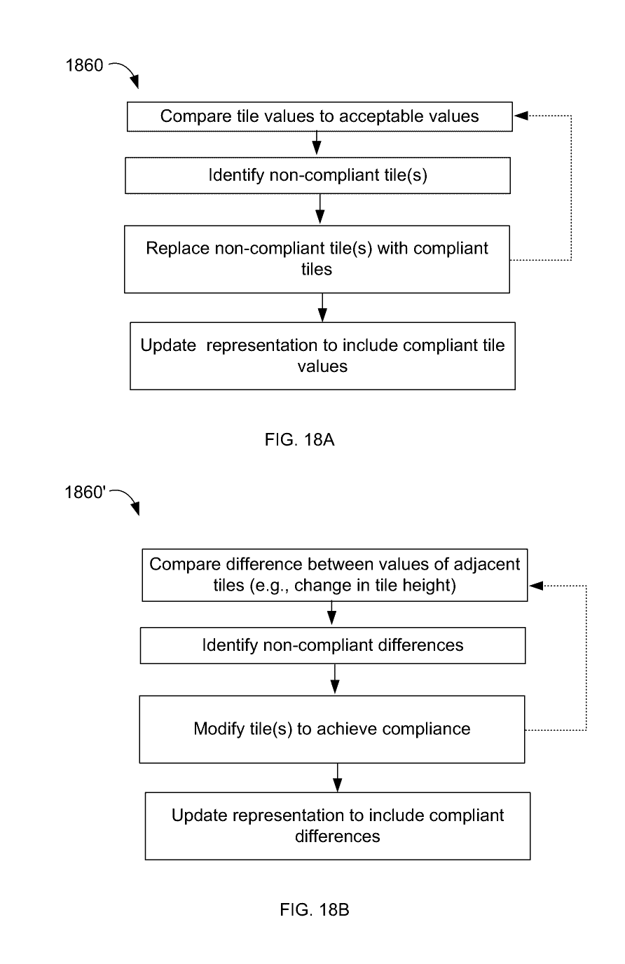

FIGS. 18A and 18B illustrate exemplary compliance calculations, according to some embodiments. Method 1860 may be used to verify the compliance of individual tiles. One or more values of a tile (e.g., dimensions, boundaries, and the like) may be compared to acceptable values. A non-compliant tile may be identified. The non-compliant tile may be replaced by a compliant tile. The representation may be updated to incorporate the compliant tile. This process may be performed iteratively.

Method 1860′ may be used to verify the compliance among tiles (e.g., of tile order). A difference between values of tiles (e.g., adjacent tiles) may be compared against a minimum and/or maximum. A non-compliant difference may be identified, and one or more tiles and/or their order may be modified to achieve compliance. The representation may be updated to include the compliant differences.

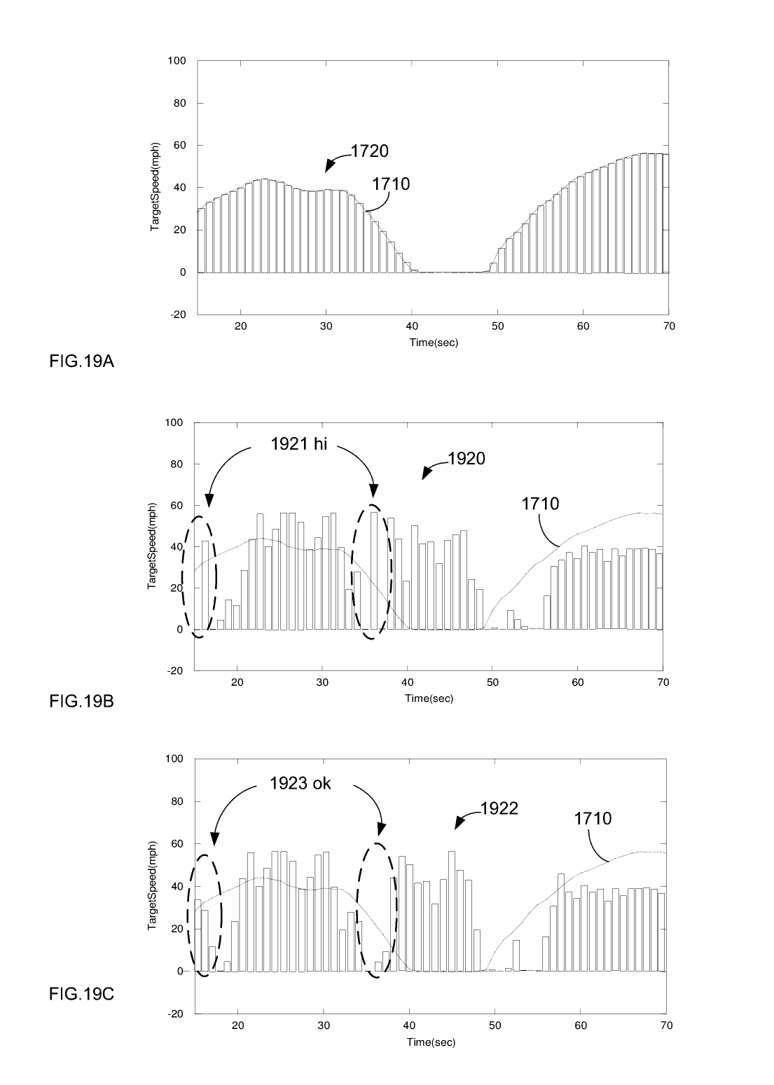

FIGS. 19A, B, and C illustrate compliance verification, according to some embodiments. FIG. 19A illustrates a target protocol 1710 and its discrete representation 1720. Discrete representation 1720 may be permuted to yield a permuted representation. FIG. 19B illustrates a first permuted representation 1920 that is noncompliant. FIG. 19C illustrates a second permuted representation 1922 that is compliant.

Compliance of a permuted representation may be represented (in this example) by calculating a derivative representation and comparing it to one or more thresholds. FIG. 19B shows two noncompliant regions 1921 in which the difference between two adjacent tiles (e.g., the “required acceleration” of a car) is too high.

FIG. 19C illustrates a second permuted representation 1922. In this example, the noncompliant portions 1921 of the noncompliant representation have been replaced with compliant portions 1923, (e.g., making representation 1922 compliant with acceleration constraints).

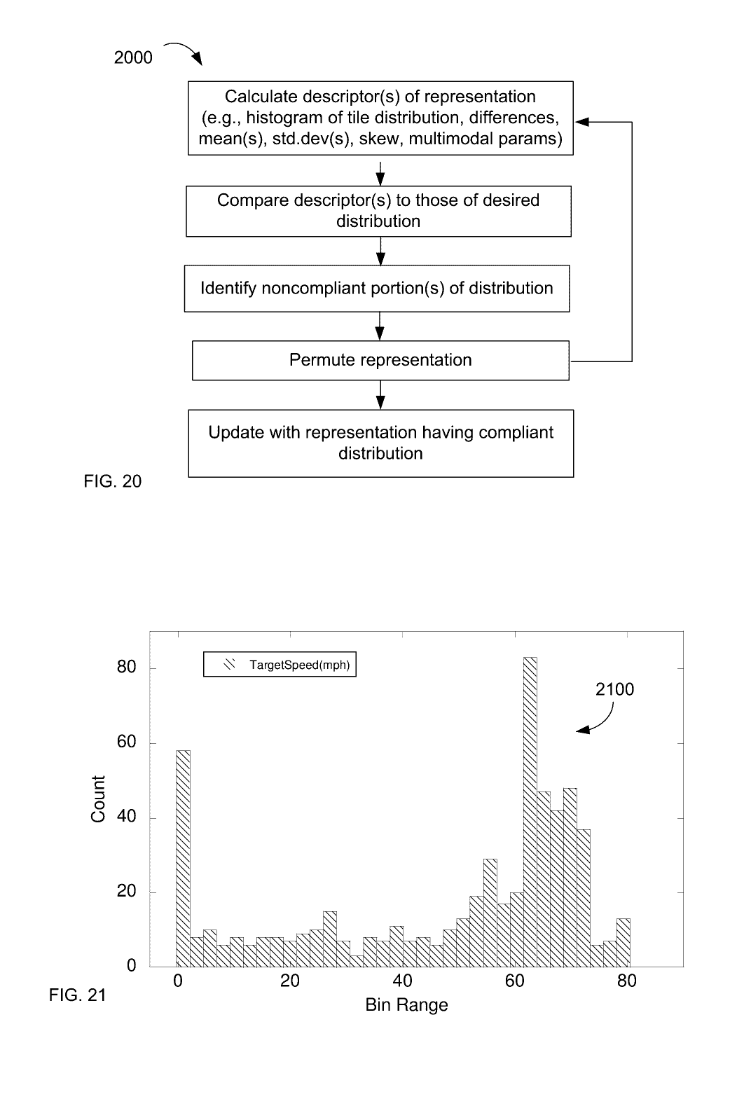

FIG. 20 illustrates an exemplary method for verifying the compliance of one or more descriptors of a representation, according to some embodiments. A statistical descriptor (e.g., mean, median, standard deviation, skew, various multimodal descriptors, histogram statistics, and the like) may describe an aggregate behavior of at least a portion of a representation (e.g., among a plurality of tiles). For a given test result, this descriptor may be compared to a limit (for that behavior) to identify noncompliance. A descriptor may comprise at least a portion of a histogram of a representation. A permutation having a noncompliant descriptor may be replaced with another permutation for which the descriptor is compliant.

One or more descriptors may be calculated. The descriptor(s) may be compared to a desired, compliant, and/or target descriptor. A deviation between the calculated and desired descriptor may identify a process to permute the distribution. In some cases, a portion of the distribution that causes the noncompliance is identified. The representation may be permuted to identify a compliant distribution, which may then be used to update the representation.

FIG. 21 illustrates an exemplary histogram, according to some embodiments. Histogram 2100 may represent the distribution of tiles in a representation (for example a representation of the US06 test). A histogram of a target protocol may be compared to a histogram of a synthesized representation to assess similarity. A permuted representation may be used to calculate its associated histogram. Histograms may be compared (e.g., to verify compliance). Over time/testing, “good” histograms associated with particular test conditions may be used to bias the selection of provided protocols.

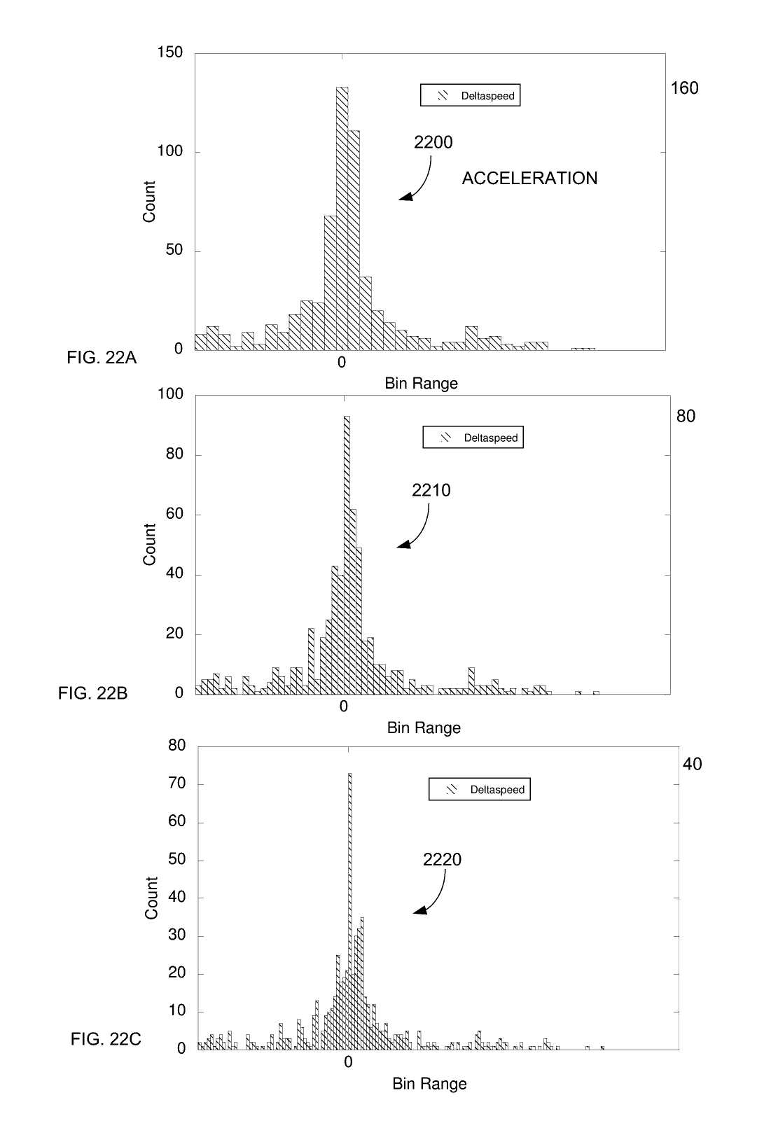

FIGS. 22A, 22B, and 22C illustrate diversity in “bin space” according to some embodiments. Bin width of a histogram may be used to diversify granularity of a permutation. For example, histograms 2200, 2210, and 2220 may describe the same discrete representation (in this case, a derivative representation). By permuting different bin combinations differently, the resulting (slightly different) representations may have increased diversity.

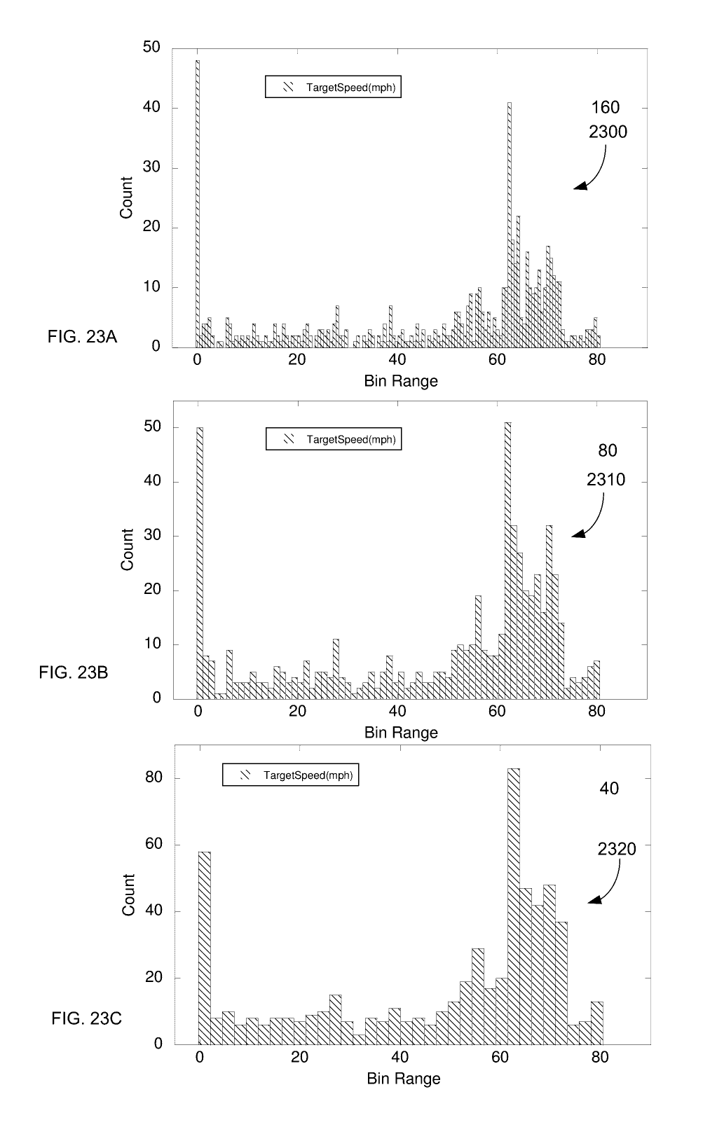

FIGS. 23A, 23B, and 23C illustrate diversity in “bin space” according to some embodiments. These histograms permute granularity in representations in a “native” representation.

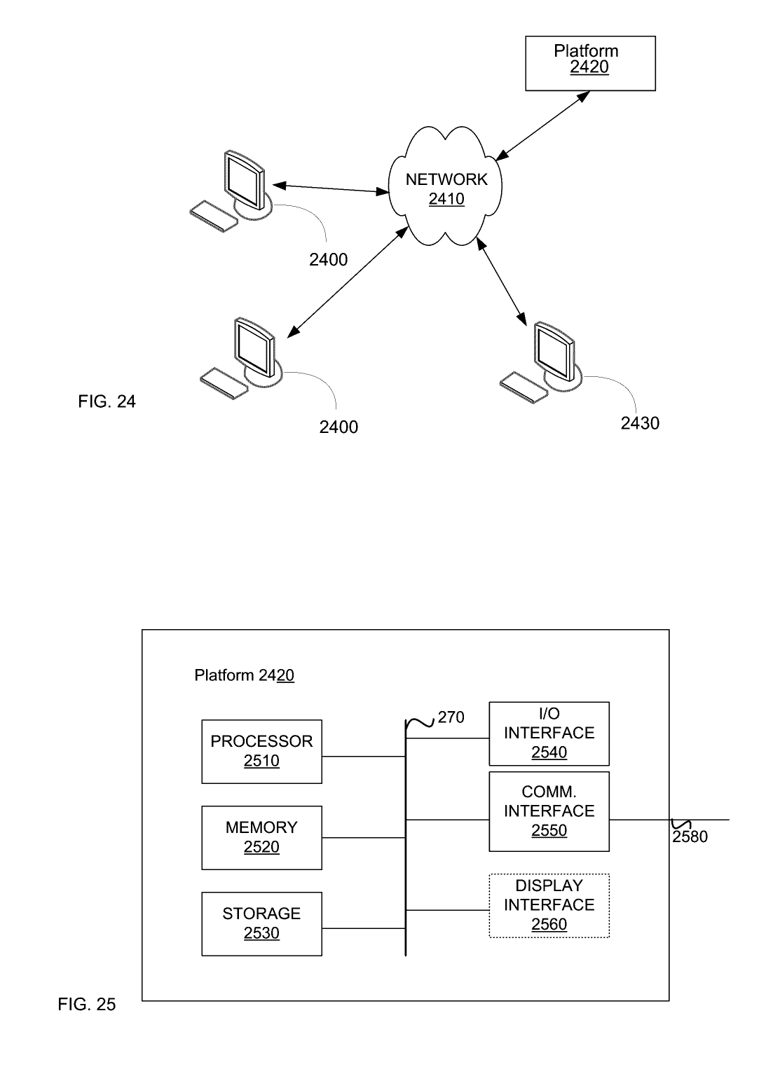

FIG. 24 illustrates a networked implementation, according to some embodiments. One or more devices 2400, 2430 may communicate via a network 2410 with a platform 2420. In some cases, one or more first devices 2430 provide test results generated with a first protocol to platform 2410, which uses these results to generate a new protocol, which is sent to a second device 2430. For example, results from a plurality of Volkswagen Golf diesel cars may be used to generate a subsequent test for another Golf diesel. In some implementations, a client device and a server device are remote from each other. Some implementations include an integrated device (e.g., that both requests and provides protocols).

FIG. 25 illustrates an exemplary implementation of a platform, according to some embodiments. Platform 2420 may include hardware (e.g., a processor, memory, non-transitory storage, and the like) and software (e.g., instructions stored in the memory and executable by the processor to perform a method). Platform 2420 may include a server, such as a web server, an application server, a database server, and the like. Platform 2420 may include or provide input for graphical and/or audio output to user devices. Platform 2420 may be configured to receive input from the user devices. In some configurations, a user device 2400 communicates with platform 2420 using a standard internet protocol (IP) over network 2410 (e.g., the internet, a WAN, LAN, and the like), and may use one or more IP addresses. In some cases, communications may include encrypted information.

A platform may comprise hardware and software that operate to deliver services according to various aspects. In exemplary embodiments, platform 2420 includes a variety of hardware components, including processor 2510, memory 2520, storage 2530, input/output (I/O) interface 2540, communication network interface 2550, and display interface 2560. These components may be generally connected via a system bus 2570. Platform 2420 may communicate (e.g., with network 2410) via communication bus 2580. In some embodiments, platform 2420 includes a video card and/or display device (not shown).

Processor 2510 may be configured to execute instructions. In some embodiments, processor 2510 comprises integrated circuits or any processor capable of processing the executable instructions. In some embodiments, processor 2510 may include a cache, a multi-core processor, a video processor, and/or other processors.

Memory 2520 may be any memory configured to store data. An example of memory 2520 includes a computer readable storage medium, which may include any medium configured to store executable instructions. For example, the memory system 2520 may include, but is not limited to, storage devices such as RAM, ROM, MRAM, flash memory, and/or memory.

Certain configurations include storage 2530 as part of platform 2420. In other configurations, storage 2530 may be implemented remotely, for example as part of a remotely located database (not shown). Storage 2530 may be any storage configured to receive, store, and provide data. Storage 2530 may also include computer readable non-transitory storage media such as a memory, a hard drive, an optical drive, and/or magnetic tape. Storage 2530 may include a database or other data structure configured to hold and organize data. In some embodiments, platform 2420 includes memory 2520 in the form of RAM and storage 2530 in the form of a hard drive and/or flash memory.

Input and output (I/O) may be implemented via I/O interface 2540, which may include hardware and/or software to interface with various remotely located devices such as a user device 2400 (FIG. 24). I/O interface 2540 may interact with a local keyboard, mouse, pointer, touchscreen and the like of user device 2400.

Communication network interface 2550 may communicate with various user devices, and such communications may include the use of network 2410 (FIG. 24). Communication network interface 2550 may support serial, parallel, USB, firewire, Ethernet, and/or ATA communications. Communication network interface 2550 may also support 802.11, 802.16, GSM, CDMA, EDGE and various other wireless communications protocols.

Display interface 2560 may include any circuitry used to control and/or communicate with a display device, such as an LED display. In some configurations, display interface 2560 includes a video card and memory. In some configurations, a user device 2400 (FIG. 24) may include a video card and graphic display, and display interface 2560 may communicate with the video card of user device 100 to display information.

The functionality of various components may include the use of executable instructions, which may be stored in computer readable storage media (e.g., memory and/or storage). In some embodiments, executable instructions may be stored in memory 2520 and/or storage 2530. Executable instructions may be retrieved and executed by processor 2510, and may include software, firmware, and/or program code. Executable instructions may be executed by the processor to perform one or more methods.

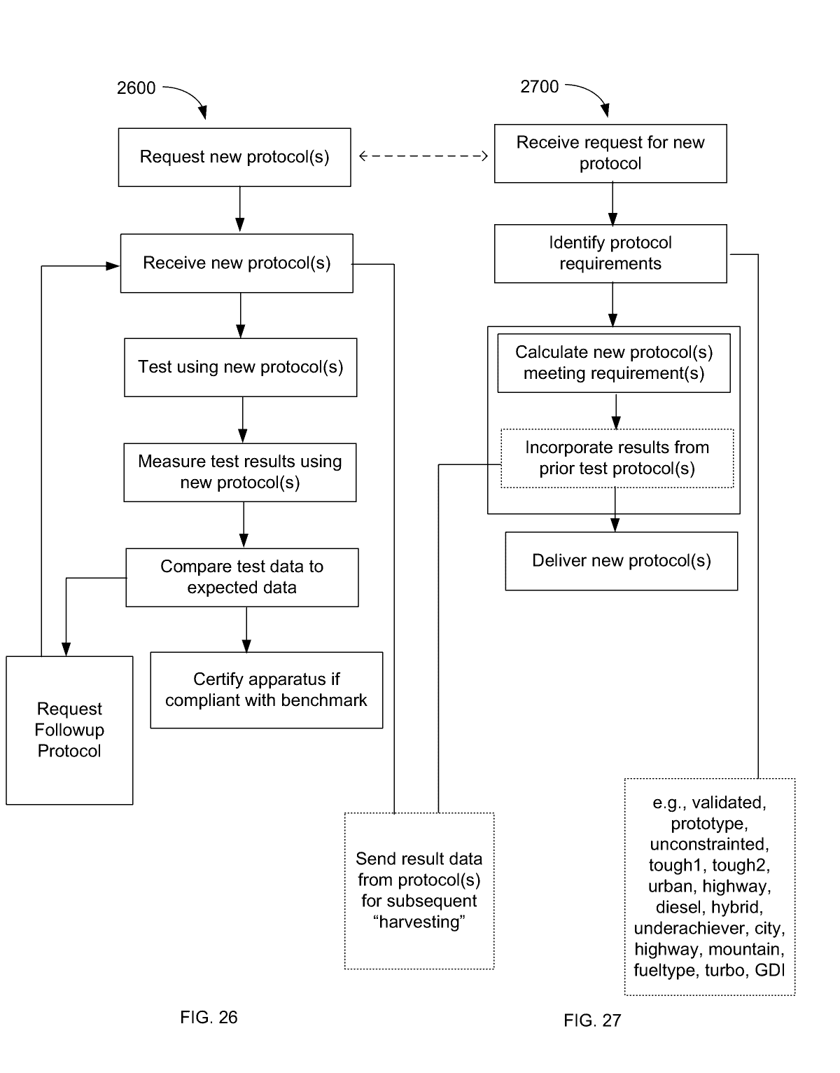

FIGS. 26 and 27 illustrate an exemplary implementation. In some cases, a client/server implementation is used. A software as a service (SaaS) implementation may be used. For example, a first device (e.g. the client side) implementing a method 2600 (FIG. 26) may interact with a second device (e.g., the server side) implementing a method 2700 (FIG. 27). The client and server devices may be integrated.

In method 2600, a new protocol may be requested (e.g., from a server) and received. A test may be performed using the new protocol, with associated results measured. The test data may be compared to expected values (e.g., benchmark data) to identify a deviation (e.g., beyond a statistically acceptable threshold). When deviation is acceptable, the tested device may be certified or otherwise “passed.” When deviation is unacceptable, a warning may be issued. In some cases, a followup protocol is requested. The followup protocol may be randomly selected. The followup protocol may be generated pursuant to a particular type of deviation (e.g., how the tested device deviated in the first test).

Test results may optionally be sent for subsequent “harvesting.” Harvesting may include incorporating the measured vs. expected results into a database, which may be used to improve an allowable or expected deviation for subsequent protocols. Harvesting may include identifying protocol features that tend to emphasize or de-emphasize certain types of performance.

In method 2700, a protocol may be requested, and the protocol requirements identified (e.g., from the request). A new protocol meeting the requirements may be selected (e.g., calculated by permuting a prior protocol). In some cases, a new protocol is determined for a specific device using prior test results for that device. The new protocol may be delivered for use in testing the device.

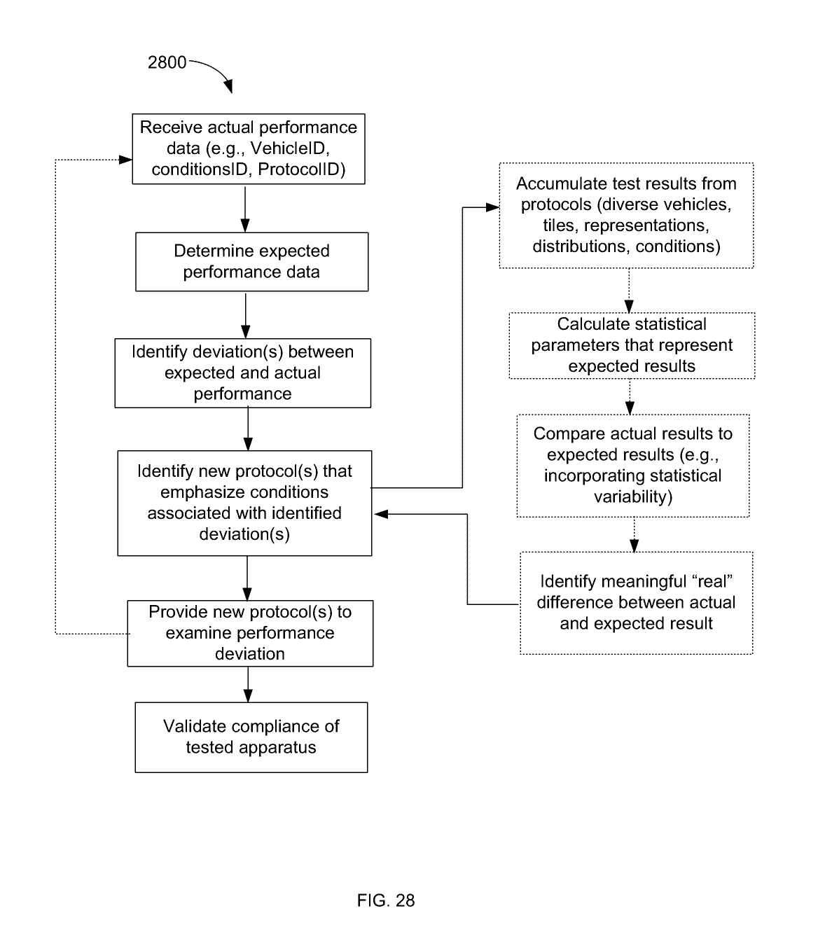

FIG. 28 illustrates an exemplary implementation. A client side device may request a protocol and impose that protocol on an apparatus being tested. A server side device may generate a protocol and provide that protocol for use in a test. In some cases, a device (e.g., a server) implementing method 2800 may receive first test results, compare those results to expected results, and (if necessary) deliver a new protocol for subsequent testing. In some cases, a protocol may be generated “on demand” or “on the fly” according to time-dependent criteria (e.g., outside temperature at test center). In some cases, a particular type of noncompliance in the first test may be used to select a second test to “follow up” the noncompliance.

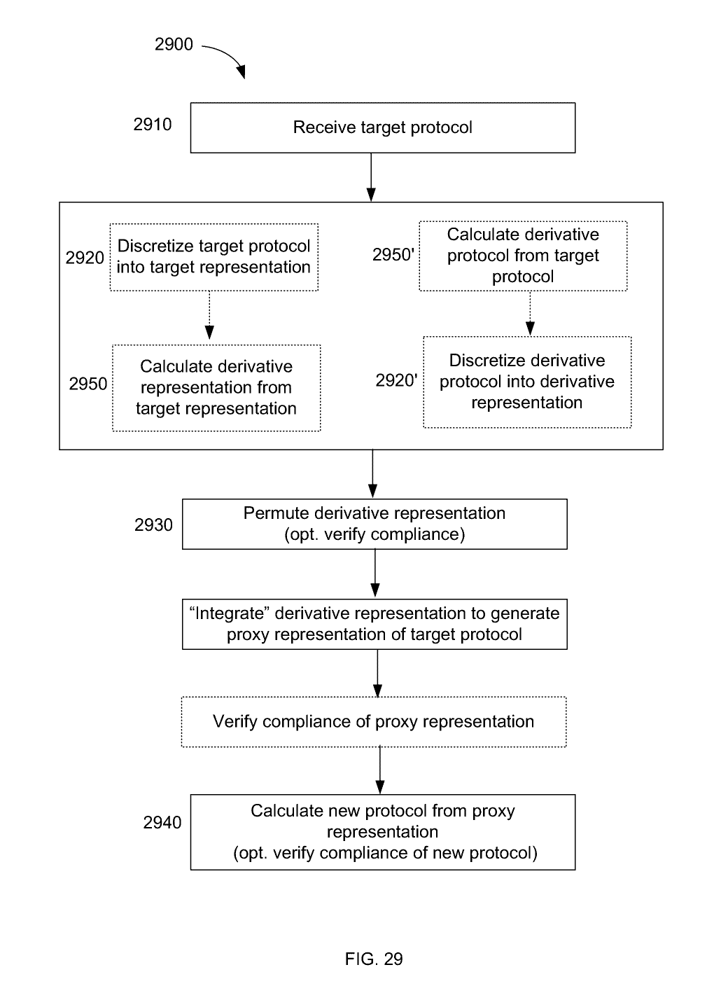

FIG. 29 illustrates a method, according to some embodiments. Method 2900 may be used to generate a new protocol by permuting one or more representations of a target protocol.

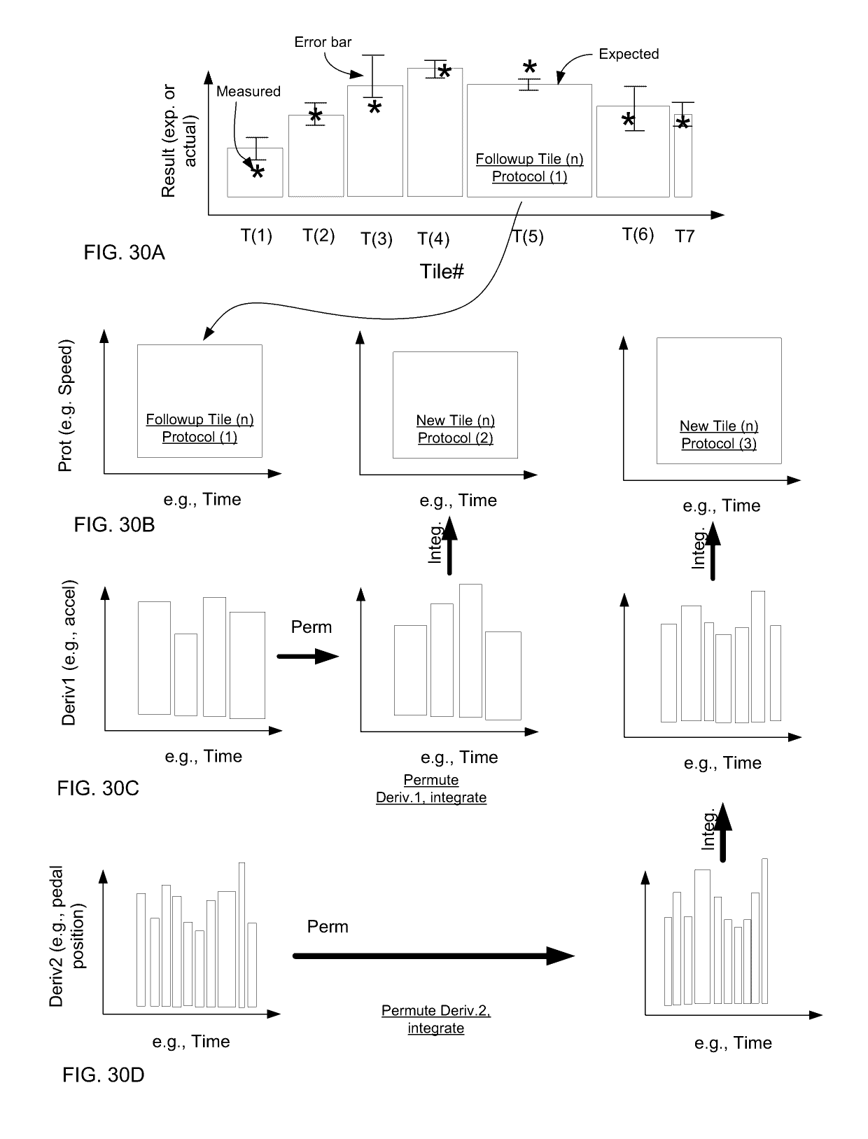

FIGS. 30A-D illustrate an exemplary illustration of protocol generation, according to some embodiments. FIG. 30A illustrates expected test results (e.g., expected tile and/or bin heights) and their respective error bars. These results may be based on a plurality of prior tests. Results from a new test (asterisks) are shown. One or more followup tiles may be identified (e.g., for which a result is statistically unexpected).

FIGS. 30B, 30C, and 30D illustrate various permutation paths to generate a followup protocol (in this case, for a single followup tile). FIG. 30C illustrates a first derivative representation of the followup tile (left side, e.g., acceleration). The first derivative representation may be permuted, and this permuted derivative representation may be integrated to yield a new tile (e.g., for protocol 2, middle of 30B).

FIG. 30D illustrates a second derivative representation of the followup tile (e.g., pedal position). In this example, the second derivative representation is permuted, then integrated twice to yield a different new tile (e.g., for protocol 3, right side of 30B). One or more new tiles may be generated to “follow up” or reassess the noncompliant behavior associated with the followup tile.

The above description is illustrative and not restrictive. An explicit combination of features does not preclude the removal of one or more features from the combination. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A protocol-generation device comprising a computer processor and non-transitory storage media having embodied thereon instructions executable by the processor to perform a method comprising:
receiving (910, 2910) a target protocol (810, 1410);
discretizing (920, 1020, 2920, 2920′) the target protocol into a discrete representation (1420) comprising a plurality of tiles (1430);
permuting (930, 1130, 2930) the discrete representation into a permuted representation (1440, 1440′);
calculating (940, 1240, 2940) a new protocol (1450, 1450′) based on the permuted representation; and
sending the new protocol to a test apparatus configured to test a test subject according to the new protocol.

2. The device of claim 1, wherein discretizing the target protocol comprises at least one of:
modifying a tile boundary;
modifying a number of tiles in the representation; and
modifying a shape of a tile.

3. The device of claim 1, wherein permuting the discrete representation comprises at least one of:
changing an order of tiles, particularly a sequence of tiles;
adding and/or subtracting one or more tiles;
changing a tile size; and
changing a tile shape.

4. The device of claim 1, further comprising:
calculating (950, 2950, 2950′) a derivative protocol (312, 314, 412);
at least one target protocol comprises the derivative protocol; and
calculating at least one new protocol comprises calculating a new protocol based on the permuted derivative protocol.

5. The device of claim 1, further comprising verifying a compliance (960, 1360, 1860, 1860′) of at least one of a permuted representation and a new protocol.

6. The device of claim 5, wherein verifying compliance comprises calculating a descriptor (2000) of a permuted representation and comparing the descriptor against a limit.

7. The device of claim 1, wherein the method further comprises:
receiving a test result from the test apparatus describing performance of the test subject according to the new protocol;
determining an expected result for at least a portion of the new protocol;
comparing the test result of the test subject to the expected result;
identifying a deviation between the test result and expected result that exceeds a threshold;
calculating an updated protocol that is expected to enhance the deviation, and sending the updated protocol to the test apparatus for use in a subsequent test.

8. The device of claim 7, wherein identifying the deviation comprises determining an operating condition associated with the deviation.

9. The device of claim 1, wherein at least one protocol comprises a desired combination of speed vs. time for a vehicle being subjected to emissions testing.

10. The device of claim 1, wherein at least one protocol comprises a range of power output vs. time for a powertrain comprising an internal combustion engine.

11. A testing device comprising a computer processor and non-transitory storage media having embodied thereon instructions executable by the processor to perform a method (2600) comprising:
requesting a new protocol of one or more test conditions;
receiving the new protocol;
performing a test on a test subject using the new protocol;
calculate a test result based on the test performed using the new protocol; and
comparing the calculated test result to a benchmark result.

12. The testing device of claim 11, further comprising requesting an updated protocol when the test result exceeds a benchmark result.

13. The device of claim 11, further comprising a powertrain interface configured to interface with a powertrain to be tested.

14. The device of claim 13, wherein the powertrain comprises an On-Board-Diagnostic (OBD) interface device configured to interface with a vehicle.

15. A car or truck having at least one of an engine and a motor and an interface configured to receive a dynamically generated test protocol.
